(19) United States
(12) Patent Application Publication
(10) Pub. No.: US 2014/0116993 A1
(43) Pub. Date: May 1, 2014

(54) SYSTEM AND METHOD FOR ARC-ION CLEANING OF MATERIAL PRIOR TO CLADDING SAME

(71) Applicant: GENERAL ELECTRIC COMPANY, Schenectady, NY (US)

(72) Inventors: David Anthony Nowak, Houston, TX (US); Vicente de Paula Ortega, Houston, TX (US); Walter de Silva Diniz, Houston, TX (US)

(73) Assignee: GENERAL ELECTRIC COMPANY, Schenectady, NY (US)

(21) Appl. No.: 13/661,218

(22) Filed: Oct. 26, 2012

(51) Int. Cl. B23K 35/38

(52) U.S. Cl. 219/74

(57) ABSTRACT

A process for cladding a surface of a substrate that includes cleaning the surface just prior to applying the cladding. Oxides, such as base metal oxides, are removed from the surface during the step of cleaning. Cleaning methods include an ionized gas cleaning process that may include forming an arc between an electrode and the surface. Optionally, the step of cleaning can occur in a chamber that is substantially evacuated. The cladding can be applied to the cleaned surface immediately after it has been cleaned.

### BACKGROUND

1. Field of Invention

The invention relates generally to a method of cladding a surface of a substrate. More specifically, the present invention relates generally to a method of cladding a surface of a substrate using an electric arc, energy beam, or resistance weld cladding process immediately or soon after the surface has been cleaned using an arc-ion cleaning process.

2. Description of Prior Art

Structural members subjected to ambient conditions are typically treated to prolong their useful life. Treatment methods generally include forming the member from a corrosive resistant material, such as stainless steel, coating the member, or cladding the member. Coatings, such as paint or polymeric compounds, can protect the surface of a member from moisture and corrosive elements that can promote oxidation or galvanic action. However, most coatings wear over time, either from exposure or from rubbing contact with another object. Therefore, to protect such members, a cladding may be required that is bonded to the outer surface of the member and cannot be easily removed or eroded.

Surfaces of an object to be protected are generally cleaned prior to application of any cladding. Cleaning a surface of the object prior to applying a cladding typically includes machining the surface and then applying a chemical cleaner, such as alcohol or acetone. The object is then usually secured and oriented so that cladding can be applied. During most cladding processes the object is often preheated to temperatures approaching 400° F. Temperatures at this level can cause oxides to form on the surface before cladding is applied.

### SUMMARY OF THE INVENTION

Disclosed herein is a method of and system for cladding a substrate. In an example, a method of forming a layer on a surface of a substrate is disclosed that involves ionizing a stream of gas and directing the ionized gas stream onto the surface. The ionized gas stream is applied to the surface for a period of time to remove oxides from the surface. A cladding material is applied onto the surface before oxides form on the surface. Alternatively, the step of ionizing a stream of gas includes flowing an inert gas adjacent an electrode and energizing the electrode to apply a negative charge to the gas. In one example, the electrode has a body with pointed members on one of its sides, passages are formed through the body that intersect with the side having the pointed members. When the gas stream flows through the passages it crosses the pointed members and becomes ionized. Electricity can be supplied to the electrode at about 80 volts, about 2500 Hz, and from about 1 milliamp to about 1 ampere. Optionally, the cladding can involve powering a welding electrode from about 8 volts to about 30 volts, from about 25 amperes to about 300 amperes. At these power levels the cladding can be welded onto the surface, this can result in an energy input to the surface from the welding electrode that ranges from about 3 KJ/in to about 180 KJ/in. In one example embodiment, the cladding material applied to the surface has a substantially uniform density and is substantially free of porous voids. Cladding the substrate can occur after anywhere from about 1 second to about 10 minutes after the surface has been cleaned with the cleaning electrode. Alternatively, the ionized gas stream can have an axis, wherein the ionized gas stream is repositioned so that the axis intersects the surface along a path on the surface, and wherein the cladding material is applied to the surface along the path and behind the ionized gas stream. The substrate may optionally be part of a tensioning mechanism used on an offshore platform or a valve on a tree.

Also disclosed herein is a method of cladding a surface of a substrate; this example embodiment includes powering a cleaning electrode with electricity at about 2500 Hz, from about 1 milliamp to about 1 ampere, and about 80 volts and flowing a stream of gas adjacent a tip of the cleaning electrode to form a flow of ionized gas. Oxides are removed from the surface by directing the flow of ionized gas onto the surface; which defines an interface where the flow of ionized gas contacts the surface. The cleaning electrode is moved so that the interface moves along a path on the surface to define a clean path. A cladding is applied on the clean path. Applying a cladding may involve contacting the clean path with a welding electrode. Power to the welding electrode can be controlled so that energy input to the cladding ranges from about 3 KJ/in to about 180 KJ/in. In an optional embodiment, cladding takes place before oxides form on the clean path. The substrate may be part of a tensioning mechanism used on an offshore platform. Yet further optionally, the cladding can be applied by spraying the clean path with cladding material.

A system for applying cladding to a surface is also provided herein that in one example embodiment is made up of a cleaning element with a tip selectively disposed proximate the surface. The tip is selectively energized with electrical potential to become an energized tip. When the energized tip is used to ionize a gas stream that is then directed at the surface, oxides are removed from the surface by the ionized gas to form a cleaned surface. The system also includes a source of cladding material that is selectively disposed proximate the cleaned surface. Alternatively, the cleaning element is made up of a body having a side on which the tip is disposed, and passages in the body that intersect the side having the tip. The system can optionally include a power source that provides electrical power to the cleaning element at about 2500 Hz, from about 1 milliamp to about 1 ampere, and about 80 volts. In an alternative, the source of cladding material is a welding electrode and a power source for the welding electrode is included, so that energy input from the welding electrode to the cladding material ranges from about 3 KJ/in to about 180 KJ/in.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side partial sectional view of an example embodiment of a method of cladding a surface of a substrate in accordance with the present invention.

FIG. 2 is an elevation view of a riser tensioner system having a surface clad in accordance with an example embodiment of the method of FIG. 1.

FIG. 3 is an elevation view of an exemplary embodiment of a ram tensioner piston rod having a surface clad in accordance with an example embodiment of the method of FIG. 1.

FIG. 4 is an overhead view of an example method of cleaning and cladding a surface of a substrate in accordance with an example embodiment of the method of FIG. 1.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation. Accordingly, the improvements herein described are therefore to be limited only by the scope of the appended claims.

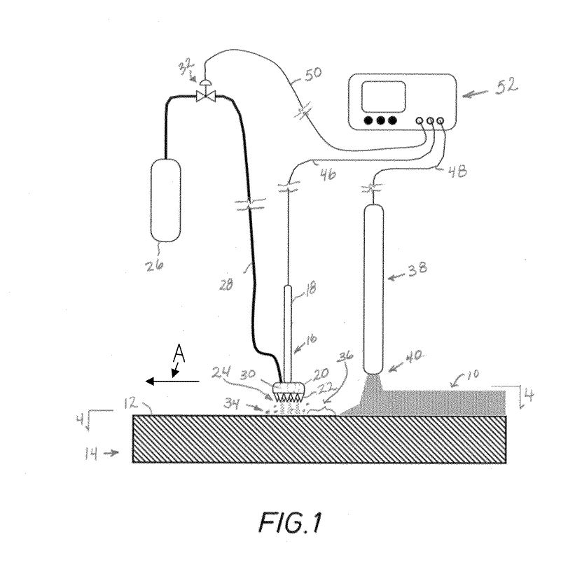

FIG. 1 illustrates in a side schematic view one example of applying a cladding 10 to a surface 12 of a substrate 14. In an example embodiment, the substrate 14 includes iron, nickel, cobalt, copper, titanium, aluminum based alloy systems, combinations thereof, and the like. In the example of FIG. 1, a cleaning element 16 is provided for cleaning the surface 12 before the cladding 10 is deposited. The cleaning element 16 of FIG. 1 includes a body 18 with a head 20 attached on one end of the body 18. Electrodes 22 are shown provided on a side of the head 20 facing the surface 12. In the example of FIG. 1, the electrodes 22 come to a point on their free end that faces the surface 12. In one example embodiment, the electrodes 22 are formed from a material that includes tungsten. An ion flow 24 is shown existing the head 20 and striking the surface 12. In the example of FIG. 1, the ion flow 24 is formed by discharging a gas from nozzles (not shown) in the head 20 while providing an electrical potential to the electrodes 22 that charges the gas molecules. The gas may be stored in a vessel 26 shown having a line 28 connected between it and the head 20 for transporting the gas to the head 20. Flow passages 30 are formed at various locations in the head 20 that channel the gas to the nozzles. A flow control valve 32 in the line 28 may optionally be provided for regulating gas flow to the head 20. Electrically charging the gas with the energized electrodes 22 generates ions that when directed towards the surface 12, physically remove oxides 34 from the surface 12 to form a cleaned space 36. Examples of the gas include argon, helium, any other inert gas, and combinations thereof; with or without active gases.

Further in the example of FIG. 1, the cleaning element 16 is shown moving in the direction of arrow A and lateral to the surface 12. In one example embodiment the cleaning element 16 continuously moves lateral to the surface 12 while the ion flow 24 is being generated. In one example, the cleaning element 16 moves at a substantially constant rate of travel. Optionally, the cleaning element 16 remains at a discrete location for a period of time while the ion flow 24 is occurring, then moves a designated distance to another discrete location where it remains for another period of time while the ion flow 24 continues. These steps of moving and remaining can repeat, and can continue until substantially all of the surface 12 is contacted by the ion flow 24. Embodiments exist wherein the ion flow 24 operates only when the cleaning electrode 24 is not moving, operates only when the cleaning electrode 24 is moving, or combinations thereof. The designated distances between steps can vary depending on the particular substrate 14 being protected. Removing the oxides 34 from the surface 12 while moving the cleaning electrode 16 creates a cleaned space 36 on the surface 12 behind where the ion flow 24 contacts the surface 12.

In the example method of FIG. 1, the cladding 10 is applied by a welding electrode 38 shown depositing cladding material 40 onto the surface 12, where the welding electrode 38 can be an electric art, an energy beam, a resistance application, or the like. In an example embodiment, the cladding material 40 can be tungsten, nickel, cobalt, iron, chromium, aluminum, yttrium, combinations thereof, and the like. Optionally, the welding electrode 38 can be part of a welding circuit so that by contacting the surface 12 with the welding electrode 38, a circuit is closed causing material of the welding electrode 38 to arc into contact with the surface and form the cladding material 40. The cladding material 40 can be applied onto the cleaned space 36 before oxides 34 can reform on the surface 12. In an example embodiment, closely following the cleaning element 16 with the welding electrode 38 allows application of cladding material 40 onto the cleaned space 36 without oxides 34 being on the surface 12. Optionally, the cladding material 40 is applied to the cleaned space 36 within a designated time frame after the cleaning element 16 treats the surface, and thus the interface 28 have been moved forward of the cleaned space 36. Optionally, the designated time frame can range from one or more seconds to multiple minutes and any time within this range. Moreover, the upper and lower limits of the time frame can be any value within the range. In one example, the designated time frame is less than a time in which oxides 34 could reform on the cleaned space 36.

The cleaning element 16 is shown separate from the welding electrode 38 in the example of FIG. 1. Though alternate embodiments exist where the cleaning element 16 and welding electrode 38 are connected to one another. Similarly, the gas feed line 28 could have a dedicated nozzle (not shown) and be separate from the cleaning electrode 16. In one example embodiment, cleaning and cladding the substrate 14 of the present method can be done at atmospheric conditions (i.e. standard temperature and pressure) and outside of an enclosure. Further optionally included are control lines 46, 48 connected respectfully to the cleaning element 16 and welding electrode 38. In an example embodiment, control lines 46, 48 provide control signals and power respectively to the cleaning element 16 and welding electrode 38. An optional controller 52 is shown connected to the control lines 46, 48 and in communication with the cleaning element 16 and welding electrode 38. In one example embodiment, the controller 52 provides control and power for operating the cleaning element 16 and welding electrode 38.

In an example of operation the cleaning element 16 is operated at a frequency of at least 2500 Hz with amperage from 1 milliamp to about 1 ampere, including all values of amperage between 1 milliamp and 1 ampere. The operating voltage of the cleaning element 16 can vary depending on distance from the surface 12. In an example, a voltage of about 80 volts is provided to the cleaning element 16 when the lowermost tips of the electrodes 22 are about 1.0 inch from the surface 12. Known welding methods typically generate more heat than needed to form a weld, where the extra heating is for removing oxides from the weld. Whereas a typical prior art tungsten inert gas (TIG) welding process imparts about 10 KJ/in onto the cladding 10 while operating at an amperage of about 50 to 100 amperes and a voltage of about 10 to 15 volts. A typical prior art metal inert gas (MIG) welding process imparts about 70 KJ/in while operating at an amperage of about 100 to 300 amperes and a voltage of about 20 to 30 volts. These prior art heating values can form voids in the clad deposit that can range up to 0.060″ in diameter; which generally requires repair welding. Not all oxides respond to the higher heat input and may still remain within the weld, which can cause disbonding between the cladding 10 and surface 12.

Removing oxides 34 from the surface 12 reduces the power input required to the electrode 38. In an example, the cladding 10 is deposited at a temperature less than that required if oxides 34 were on the surface 12 when the cladding 10 is applied. For example, heating values from the welding electrode 38 range from about 3 KJ/in to about 180 KJ/in. Thus advantages of the lower power/heating input include eliminating porosity in the cladding 10 and creating a stronger higher quality bond between the cladding 10 and surface 12 to form a cladding 10 of higher strength without the need for repair. Also, heat input when applying the cladding 10 on a surface 12 substantially free of oxides 34 can be less that the heat input required when oxides 34 are present. Lowering the heat input reduces how much of the cladding 10 penetrates into the substrate 14, which in turn reduces how much material from the substrate 14 flows into the cladding 10. Less material from the substrate 14 in the cladding 10 means a lower amount of cladding 10 is required to protect the surface 12. The amount of cladding applied using the present method can be as low as 50% of that of prior art methods.

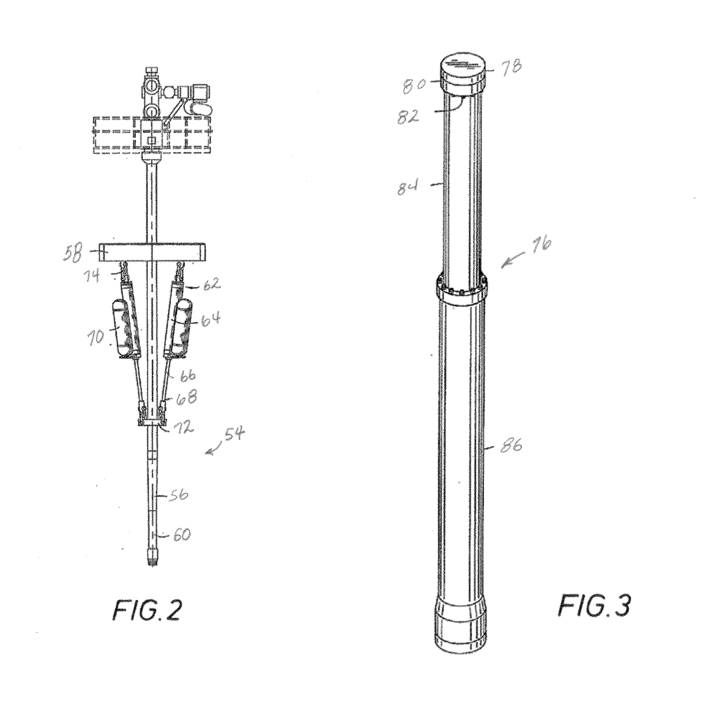

The article being treated and/or protected may be a part of a system used for producing hydrocarbons from a subsea wellhead. In one example, the article is included in a riser tensioning device used in a subsea well. The riser tensioning device can be what is referred to in the art as a “pull-up” type of a “push-up” type. With reference now to FIG. 2, an example of a tensioning mechanism 54 is shown in a side view. A riser 56 extends downwardly from a platform 58 to a subsea wellhead (not shown). Riser 56 has a longitudinal axis 60 and is surrounded by a plurality of hydraulic cylinders 62. Each hydraulic cylinder 62 has a cylinder housing 64 having a chamber (not shown). A piston rod 66 has a rod end 68 that extends downward from each cylinder housing 64 and hydraulic cylinder 62. The piston ends of rods 66 opposite rod ends 68 are disposed within the respective chambers (not shown) of cylinder housings 64. Hydraulic fluid (not shown) is contained within the housing 64 for pulling piston rods 66 upward. Each hydraulic cylinder 62 also has accumulator 70 for accumulating hydraulic fluid from hydraulic cylinder 62 and for maintaining high pressure on the hydraulic fluid. A riser collar 72 rigidly connects to riser 56. The piston rods 66 attach to riser collar 72 at the rod ends 68. Cylinder shackles 74 rigidly connect cylinder housings 64 to platform 58. In a specific example of use, the treating method described herein is used to protect a piston rod, such as the piston rod 66 of FIG. 2.

In another embodiment, a cladding method disclosed herein can be applied to a ram tensioner piston rod. An example of a hydro-pneumatic tensioner unit 76 is provided in a side view in FIG. 3. On the tensioner unit 76 upper end is a rod end cap 78 used for connection to a top plate (not shown) to provide tension to a riser system. The rod end cap 78 is shown as threadingly attached to a shoulder or flange 80 formed of or attached to the main body of a tensioner piston rod 84; bolts 82 are shown coupling the end cap 78 and piston rod 84. In an embodiment, the lower end of the tension unit 76 is connected to the operational marine platform (not shown). The tensioner piston rod 84 reciprocates in a housing 86 in response to movement of the operational platform 58 (FIG. 2).

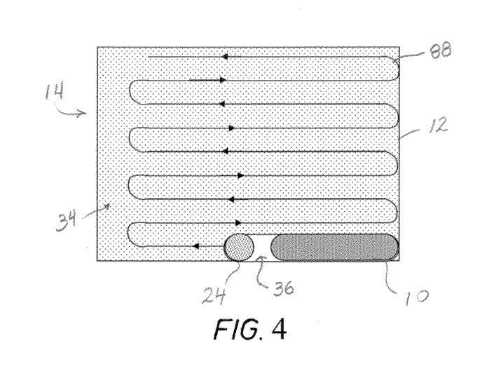

Shown in FIG. 4 is an overhead view of an example method of cleaning and cladding a surface 12 of the substrate 14 and taken along lines 4-4 of FIG. 1. As shown in the example of FIG. 4, the cleaning element 16 (FIG. 1) moves laterally above the surface 12 so that the interface 28 moves along a path 88 on the surface 12. As discussed above, creating the interface 28 on the surface 12 forms a cleaned space 36 that remains behind after the cleaning element 16 (FIG. 1) and interface 28 have moved along the surface 12. By following the path 88 and within a time frame so that oxides 34 do not reform in the cleaned space 36, the welding electrode 38 (FIG. 1) deposits cladding material 40 (FIG. 1) to form a cladding 10 on the surface 12. By moving along the path 88 as set out on FIG. 4, substantially all of the surface 12 is cleaned and clad without oxides 34 being present between the cladding 10 and surface 12.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. For example, the cladding process can processes where the material is deposited via chemical vapor deposition, a plasma spray, a high velocity air fuel, a high velocity oxygen fuel, and the like.

These and other similar modifications will readily suggest themselves to those skilled in the art, and are intended to be encompassed within the spirit of the present invention disclosed herein and the scope of the appended claims.

What is claimed is:

1. A method of forming a layer on a surface of a substrate comprising:
heating the surface;
directing an ionized gas stream on the surface to remove oxides from the surface that form when heating the surface; and
cladding material onto the surface before oxides form on the surface.

2. The method of claim 1, wherein the step of ionizing a stream of gas comprises flowing a gas selected from the list consisting of an inert gas and an active gas adjacent an electrode and energizing the electrode to apply a negative charge to the gas.

3. The of method of claim 2, wherein the electrode comprises a body with members projecting from a side of the body and passages through the body and intersecting the side with the members, and wherein the gas stream flows through the passages and across the members.

4. The of method of claim 2, wherein electricity is supplied to the electrode at about 80 volts, about 2500 Hz, and from about 1 milliamp to about 1 ampere.

5. The method of claim 1, wherein the step of cladding welding the material onto the surface comprises providing a welding electrode having an electrical potential of from around 8 volts to about 30 volts and a current of from about 30 amperes to about 300 amperes, contacting the clean path with the electrode, and controlling power to the welding electrode so that energy input to the cladding ranges from about 3 KJ/in to about 180 KJ/in.

6. The method of claim 1, wherein the cladding material applied to the surface has a substantially uniform density and is substantially free of porous voids.

7. The method of claim 1, wherein the step of applying a cladding material takes place after the period of time at a time of from about 1 second to about 10 minutes.

8. The method of claim 1, wherein the ionized gas stream has an axis, wherein the ionized gas stream is repositioned so that the axis intersects the surface along a path on the surface, and wherein the cladding material is applied to the surface along the path and behind the ionized gas stream.

9. The method of claim 1, wherein the substrate is part of a tensioning mechanism used on an offshore platform.

10. A method of cladding a surface of a substrate comprising:
powering a cleaning electrode with electricity at about 2500 Hz, from about 1 milliamp to about 1 ampere, and about 80 volts;
flowing a stream of gas adjacent a tip of the cleaning electrode to form a flow of ionized gas;
removing oxides from the surface by directing the flow of ionized gas onto the surface to define an interface where the flow of ionized gas contacts the surface;
moving the cleaning electrode so that the interface moves along a path on the surface to define a clean path; and
applying a cladding on the clean path.

11. The method of claim 10, wherein the step of applying a cladding comprises providing a welding electrode, contacting the clean path with the electrode, and controlling power to the welding electrode so that energy input to the cladding ranges from about 3 KJ/in to about 180 KJ/in.

12. The method of claim 10, wherein the step of applying a cladding takes place before oxides form on the clean path.

13. The method of claim 10, wherein the substrate is part of a tensioning mechanism used on an offshore platform.

14. The method of claim 10, wherein the step of applying a cladding comprises spraying the clean path with cladding material.

15. A system for cladding a surface comprising:
a cleaning element having a tip selectively disposed proximate the surface and selectively energized with electrical potential to define an energized tip, the cleaning element being configured to receive a gas and direct a gas stream towards the surface so that the gas stream becomes ionized by the energized tip, whereupon oxides are removed from the surface by the ionized gas stream to form a cleaned surface; and
a cladding element adapted to clad a material onto the surface, the cladding element having a welding electrode selectively disposed proximate the surface and selectively energized to produce an arc between the electrode and the surface.

16. The system of claim 15, wherein the cleaning element comprises a body having a side on which the tip is disposed, and passages in the body that intersect the side having the tip.

17. The system of claim 15, further comprising a power source to provide electrical power to the cleaning element.

18. The system of claim 15, further comprising a power source to provide power to the welding electrode.

19. The system of claim 15, wherein the cleaning element and cladding element are housed in a welding torch assembly.

20. The system of claim 15, wherein the system comprises a movement system to move the surface relative to the cleaning element and cladding element and/or move the cleaning element and cladding element relative to the surface so that the cladding element clads material onto the cleaned surface.
